(19) United States
(12) Patent Application Publication
(10) Pub. No.: US 2023/0307780 A1
(43) Pub. Date: Sep. 28, 2023

(54) DEGASSING UNIT, MEMBRANE, AND METHOD OF MANUFACTURING MEMBRANE

(71) Applicant: MANN+HUMMEL GmbH, Ludwigsburg (DE)

(72) Inventors: Thomas TSCHECH, Marbach (DE); Alrun SPENNEMANN, Stuttgart (DE); Juergen KOSICKI, Erligheim (DE); Thomas SCHLEIDEN, Oberstenfeld (DE)

(21) Appl. No.: 18/323,825

(22) Filed: May 25, 2023

Related U.S. Application Data
(63) Continuation of application No. PCT/EP2022/079603, filed on Oct. 24, 2022.

(30) Foreign Application Priority Data
Nov. 15, 2021 (DE) 102021129752.4

(51) Int. Cl. H01M 50/342; H01M 50/30

(52) U.S. Cl. CPC H01M 50/3425; H01M 50/394; H01M 2200/20; H01M 2220/20

(57) ABSTRACT

A degassing unit for a housing includes a membrane, and a base body connectable in a fluid-tight manner to an edge of a housing opening of the housing and including an exterior side, an interior side, and a gas passage opening that is closed by the membrane. The membrane is fluid-tightly connected to the base body at an edge surrounding the gas passage opening. The membrane includes weakened areas in which mechanical properties of the membrane are weakened by any one or any combination of a local melting of a material using a laser, scribing and embossing. The membrane further includes a central area interposed between the weakened areas, the central area remaining unweakened. A burst pressure at which the membrane releases the gas passage opening is reduced at least in the weakened areas compared to the central area.

### CROSS-REFERENCE TO RELATED APPLICATIONS

This application is a continuation application of International Application No. PCT/EP2022/079603 filed on Oct. 24, 2022, which claims the benefit of German Application No. 102021129752.4 filed on Nov. 15, 2021, the entire disclosures of which are incorporated herein by reference for all purposes.

### BACKGROUND

The invention relates to a degassing unit for a housing, in particular of a battery, in particular of a traction battery of a motor vehicle, to a housing, in particular of a battery housing, in particular of a traction battery of a motor vehicle, for accommodating battery cells with a degassing unit, as well as to a manufacturing method of a membrane of a degassing unit. Furthermore, the invention relates to a membrane for the degassing unit.

Housings for accommodating electronic components, such as battery cells and the like, are usually not completely sealed in a gas-tight manner with respect to the environment. On the one hand, due to temperature fluctuations, for example because of heat input during charging or discharging of battery cells, and on the other hand, due to naturally occurring air pressure fluctuations, in particular in mobile systems, a gas exchange between the interior space and the external space has to be made possible. Gas exchange can prevent inadmissible mechanical loads on the housing, in particular bursting or bulging of the housing. On the other hand, an emergency venting function must be provided, particularly in battery housings, if the pressure suddenly increases due to the failure of battery cells.

Likewise, it is equally important that the penetration of foreign matter, dirt and moisture in the form of liquid water is effectively prevented. As a result, pressure compensation devices are known which have semi-permeable membranes, for example made of extruded polytetrafluoroethylene (PTFE), which are gas-permeable but fluid-impermeable.

DE 102012022346 B4 discloses a battery housing featuring a housing enclosing a housing interior space with a housing opening covered by means of a membrane carrier in the form of a housing cover provided for degassing and for essentially watertight sealing of the housing interior space against penetration of water or other liquids. The housing cover has a carrier body featuring a gas passage opening extending continuously between an inner side of the carrier body and an outer side of the carrier body for discharging gases or for pressure compensation. The gas passage opening is completely covered by a semi-permeable membrane. The carrier body, the membrane and the housing are connected in an air-tight or gas-tight manner such that substantially no water and preferably no air or gas can pass through the housing opening into the housing interior space.

### SUMMARY

One object of the invention is to provide a degassing unit for a housing, in particular of a battery, in particular of a traction battery of a motor vehicle, which allows a rapid pressure decrease in the housing already at a low degassing pressure.

A further object is to create a membrane suitable for a degassing unit according to the invention, which is characterized by an optimized bursting behavior.

A further object is to provide a housing, in particular a battery housing, with a degassing unit, which allows a rapid pressure decrease in the housing already at a low degassing pressure.

A further object is to specify a method for manufacturing a membrane of a degassing unit, which allows a rapid pressure decrease in the housing already at a low degassing pressure.

The aforementioned object is solved according to one aspect of the invention by a degassing unit for a housing, in particular of a battery, in particular of a traction battery of a motor vehicle, with a base body which can be connected in a fluid-tight manner to an edge of a housing opening of the housing and with an exterior side and an interior side and which has at least one gas passage opening which is closed by a flat stretched membrane, wherein the membrane is connected in a fluid-tight manner to the base body at an edge enclosing the gas passage opening, wherein the membrane features at least one weakened area in which mechanical properties of the membrane are weakened by a local treatment, in particular by a local melting of the material using a laser, and/or by a mechanical treatment, in particular by means of scoring and/or embossing, and a burst pressure, at which the membrane releases the gas passage opening, is reduced at least in the weakened area compared to the untreated membrane.

According to a further aspect of the invention, the further object is solved by a membrane for a degassing unit. The membrane features at least one weakened area in which mechanical properties of the membrane are weakened by a local treatment, in particular by a local melting of the material using a laser, and/or by a mechanical treatment, in particular by means of scribing and/or embossing, and a burst pressure, at which the membrane releases a gas passage opening covered by it, is reduced at least in the weakened area compared to the untreated membrane.

According to a further aspect of the invention, the further object is solved by a housing, in particular by a battery housing, in particular of a traction battery of a motor vehicle, for accommodating battery cells, which features at least one housing wall with a housing opening, wherein the housing opening is closed by a degassing unit.

According to a further aspect of the invention, the further object is solved by a method for manufacturing a membrane of a degassing unit for a housing, in particular of a battery, in particular of a traction battery of a motor vehicle, with a base body which can be connected in a fluid-tight manner to an edge of a housing opening of the housing and which features an exterior side and an interior side and which features at least one gas passage opening which is closed by a flat stretched membrane, wherein the membrane is connected to the base body in a fluid-tight manner at an edge enclosing the gas passage opening, wherein the method comprises at least one local treatment of the membrane, in particular a local melting of the material using a laser, and/or a mechanical treatment, in particular by means of scribing and/or embossing, in at least one weakened area, by means of which mechanical properties of the membrane are weakened and a burst pressure, at which the membrane releases the gas passage opening, is reduced at least in the weakened area compared to the untreated membrane.

It is needless to say that the objects of the invention may be used not only in mobile batteries, in particular traction batteries of motor vehicles, but also in stationary batteries, for example in electricity storage facilities of buildings.

Favorable embodiments and advantages of the invention will become apparent from the further claims, the description and the drawing.

According to one aspect of the invention, a degassing unit for a housing is proposed, in particular of a battery, in particular of a traction battery of a motor vehicle, with a base body which can be connected in a fluid-tight manner to an edge of a housing opening of the housing and with an exterior side and an interior side and which features at least one gas passage opening which is closed by a flat stretched membrane, wherein the membrane is connected in a fluid-tight manner to the base body at an edge enclosing the gas passage opening. The membrane features at least one weakened area in which mechanical properties of the membrane are weakened by a local treatment, in particular by a local melting of the material using a laser, and/or a mechanical treatment, in particular by means of scribing and/or embossing and a burst pressure, at which the membrane releases the gas passage opening, is reduced at least in the weakened area compared to the untreated membrane.

As part of a safety device of a housing, in particular of a battery housing, the proposed degassing unit can release a housing opening in a defined range of overpressure in the housing. This is made possible by a plastic membrane which closes the housing opening in the normal state and already tears at a low overpressure.

Advantageously, it is not necessary for the membrane to be of a correspondingly thin design for this purpose, which would make the manufacture of the membrane more expensive and the handling more complicated during assembly. On the contrary, thicker films, which are commercially available in a wide range of thicknesses, may be used as membrane in the proposed degassing unit. In order to meet the burst pressure requirements, the thickness of the membrane is reduced in a local area or mechanical properties of the membrane are weakened such that the This local and defined modification of the mechanical properties can be done by melting and vaporizing material of the membrane, which can be done for example using a laser treatment or by a mechanical treatment such as, for example, embossing or scribing. The geometry of the weakened area may be chosen differently depending on the burst pressure requirements and may be, for example, linear, cross-shaped, spiral-shaped or grid-shaped. The weakening of the membrane can be realized on one side or on both sides. By so doing, a reduction of the burst pressure (compared to an untreated/unweakened membrane) can be achieved, for example, by up to 90%.

By reducing the burst pressure, the area of the housing opening for emergency degassing can be of a smaller design. As a result, the degassing unit itself can be reduced in size, thus saving space in the housing or on the exterior side of the housing, depending on whether the degassing unit is disposed inside or outside the housing.

A higher flexibility for selecting the material and/or the film and/or the thickness of the film can be achieved. A particular film can be adapted to different requirements. Thicker membranes can be handled more easily in production. Advantageously, both technical and commercial benefits can be achieved.

When assembled, the interior side or the exterior side of the base body can be directed towards the housing opening, allowing assembly either from the exterior side or from the interior side of the battery housing.

According to a favorable embodiment of the degassing unit, a thickness of the membrane can be reduced in the at least one weakened area. In particular, the at least one weakened area may feature a residual wall thickness of at least 5 μm, preferably of at least 8 μm. Advantageously, the residual wall thickness results from the process parameters in conjunction with the film material used.

According to a favorable embodiment of the degassing unit, the shape and/or size of the at least one weakened area of the membrane may be designed as a function of a set value of the burst pressure.

Laser treatment advantageously allows easy programmability of the weakening to be produced. The weakened area can be varied both in shape and in depth. In doing so, the contour of the cut can also be adjusted within limits, whereby the weakening can be additionally characterized.

It is also possible that a simple weakening is produced mechanically, for example using a scalpel. Such a weakening can also be achieved using a hot punch or a cutting edge.

According to a favorable embodiment of the degassing unit, the membrane may be formed from a thermoplastic, particularly as a multilayer film, especially polypropylene or polyethylene terephthalate or polybutylene terephthalate. Such materials can be advantageously processed during manufacture.

According to a favorable embodiment of the degassing unit, the membrane may be formed as a multilayer film and at least one film of the multilayer film, which is connected, in particular welded, to the base body, is formed from a material of the base body, in particular from polypropylene. As an alternative or additionally, a further film of the multilayer film may be formed as a polymer film, in particular as an elastomer film. Advantageously, multilayer films may be used in which a component may be welded well to the base body, for example because it is made of the same material as the base body.

According to a favorable embodiment of the degassing unit, the membrane may also be formed as a composite film and/or hybrid film. In particular, the membrane may be formed from a thermoplastic which is laminated and/or vapor-deposited with a metallic layer. Equally advantageously, composite and/or hybrid films may be used as a burst membrane.

According to a favorable embodiment of the degassing unit, the membrane may feature a wall thickness of at least 30 μm and at most 200 μm. For example, the initial thickness of the membrane or film may be at least 30 μm. The film can then inflate even at low overpressure in the direction of an emergency degassing mandrel on the base body, causing the film to tear. For example, a maximum thickness may be 200 μm, depending on the material.

According to a favorable embodiment of the degassing unit, at least one weakened area may be disposed on both sides of the membrane. In this way, a desired burst pressure of the membrane can be advantageously adjusted.

According to a favorable embodiment of the degassing unit, the membrane may be gas-tight or semi-permeable, thereby allowing gaseous media to pass from an environment into the housing and vice versa, and preventing liquid media and/or solids from passing therethrough.

Non-porous films in the form of polymer films, for example, may be used as gas-impermeable films. Laminated films or silver-vaporized films may be used to ensure the tightness of the housing during the intended operation.

All materials featuring a gas permeability for aeration/deaeration in normal operation and a sufficiently high-water impermeability may be used as semi-permeable film. Polytetrafluoroethylene (PTFE) may be used as preferred material for the semi-permeable film. The semi-permeable film may feature an average pore size that may range from 0.01 micrometer to 20 micrometer. The porosity may be preferably about 50%; the average pore size may be preferably about 10 micrometer.

According to a favorable embodiment of the degassing unit, the at least one weakened area can be linear or cross-shaped or rectangular or circular or spiral-shaped or grid-shaped at least in some areas. The course of the weakening may be very diverse in order to achieve a desired burst pressure and a desired bursting behavior of the membrane.

According to a favorable embodiment of the degassing unit, the base body may feature an emergency degassing mandrel disposed on the exterior side and with a tip directed towards the interior side, by means of which the membrane, which is distended towards the exterior side due to an overpressure in the housing, can be pierced. The emergency degassing mandrel can deliberately cause the distended membrane to burst, so that the overpressure in the housing can be quickly relieved. The weakening serves as a predetermined breaking point along which the membrane ruptures when the material strength is exceeded. The emergency degassing mandrel acts as an initiator for the crack formation.

According to a favorable embodiment of the degassing unit, the membrane may be firmly connected to the base body, in particular welded or bonded. In this way, a secure and fluid-tight connection to the base body is possible, so that the gas passage opening is normally sealed in a fluid-tight manner.

According to a favorable embodiment of the degassing unit, the membrane can be present on the interior side of the base body. In this way, a fluid-tight connection of the membrane to the base body is possible and a defined tearing of the membrane at a corresponding overpressure when the membrane bulges outwards can be reliably set. The risk that the joint seam with the base body fails prematurely can be reduced.

According to a further aspect of the invention, a membrane for a degassing unit according to the invention is proposed. The membrane features at least one weakened area in which mechanical properties of the membrane are weakened by a local treatment, in particular by a local melting of the material using a laser, and/or by a mechanical treatment, in particular by means of scribing and/or embossing, and a burst pressure, at which the membrane releases a gas passage opening covered by it, is reduced at least in the weakened area compared to the untreated membrane.

All features disclosed in relation to the degassing unit according to the invention and relating to the membrane are transferable to the membrane according to the invention. The membrane according to the invention thus comprises a plurality of feature combinations according to the invention.

According to a further aspect of the invention, a housing, in particular a battery housing, in particular of a traction battery of a motor vehicle, for accommodating battery cells, which features at least one housing wall with a housing opening, is proposed, wherein the housing opening is closed by a degassing unit according to the invention or by a membrane according to the invention. That is, in embodiments of the housing according to the invention, the housing opening may be directly closed by a membrane according to the invention, which is circumferentially fluid-tightly connected to an edge of the housing opening, in particular welded or bonded.

As part of a safety device of a proposed housing, in particular of a battery housing, the degassing unit can release a housing opening in a defined range of overpressure in the housing. This is made possible by a plastic membrane which closes the housing opening in the normal state and already tears at a low overpressure.

Advantageously, it is not necessary for the membrane to be of a correspondingly thin design for this purpose, which would make the manufacture of the membrane more expensive and the handling more complicated during assembly. On the contrary, thicker films, which are commercially available in a wide range of thicknesses, may be used as membrane in the proposed degassing unit. In order to meet the burst pressure requirements, the thickness of the membrane is reduced in a local area or mechanical properties of the membrane are weakened such that the membrane may tear at low pressures.

According to a further aspect of the invention, a method for manufacturing a membrane for a degassing unit for a housing is proposed, in particular of a battery, in particular of a traction battery of a motor vehicle, with a base body which can be connected in a fluid-tight manner to an edge of a housing opening of the housing and with an exterior side and an interior side and which features at least one gas passage opening which is closed by a flat stretched membrane, wherein the membrane is connected in a fluid-tight manner to the base body at an edge enclosing the gas passage opening. The method comprises at least a local treatment of the membrane, in particular a local melting of the material using a laser, and/or a mechanical treatment, in particular by means of scribing and/or embossing, in at least one weakened area by means of which mechanical properties of the membrane are weakened and a burst pressure, at which the membrane releases the gas passage opening, is reduced at least in the weakened area compared to the untreated membrane.

As part of a safety device of a housing, in particular of a battery housing, the degassing unit can release a housing opening in a defined range of overpressure in the housing. This is made possible by a plastic membrane which closes the housing opening in the normal state and already tears at a low overpressure.

Advantageously, it is not necessary for the membrane to be of a correspondingly thin design for this purpose, which would make the manufacture of the membrane more expensive and the handling more complicated during assembly. On the contrary, thicker films, which are commercially available in a wide range of thicknesses, may be used as membrane in the proposed degassing unit. In order to meet the burst pressure requirements, the thickness of the membrane is reduced in a local area or mechanical properties of the membrane are weakened such that the This local and defined modification of the mechanical properties can be done by melting and vaporizing material of the membrane, which can be done for example using a laser treatment or by a mechanical treatment such as, for example, embossing or scribing. The geometry of the weakened area may be chosen differently depending on the burst pressure requirements and may be, for example, linear, cross-shaped, spiral-shaped or grid-shaped. The weakening of the membrane can be realized on one side or on both sides. By so doing, a reduction of the burst pressure (compared to an untreated/unweakened membrane) can be achieved, for example, by up to 90%.

A higher flexibility for selecting the material and/or the film and/or the thickness of the film can be achieved. A particular film can be adapted to different requirements. Thicker membranes can be handled more easily in production. Advantageously, both technical and commercial benefits can be achieved.

According to a favorable embodiment of the manufacturing method, the weakened area can be at least in some areas linear or cross-shaped or rectangular or circular or spiral-shaped or grid-shaped. The course of the weakening may be very diverse in order to achieve a desired burst pressure and a desired bursting behavior of the membrane.

### BRIEF DESCRIPTION OF DRAWINGS

Further advantages will become apparent from the following drawing description. The drawings show examples of an embodiment of the invention. The drawings, the description and the claims contain numerous features in combination. The person of skill in the art will expediently consider the features also individually and combine them to other meaningful combinations. Examples are shown in:

FIG. 1 is a longitudinal section through a degassing unit according to an embodiment example of the invention;

FIG. 2 is a top view of a membrane of the degassing unit according to an embodiment example of the invention;

FIG. 3 is a top view of a membrane of the degassing unit according to a further embodiment example of the invention;

FIG. 4 is a top view of a membrane of the degassing unit according to a further embodiment example of the invention;

FIG. 5 is a top view of a membrane of the degassing unit according to a further embodiment example of the invention; and

FIG. 6 is a top view of a membrane of the degassing unit according to a further embodiment example of the invention.

### DETAILED DESCRIPTION

Identical or similar components in the figures have the same reference numerals. The figures only show examples and are not to be understood in a restrictive way.

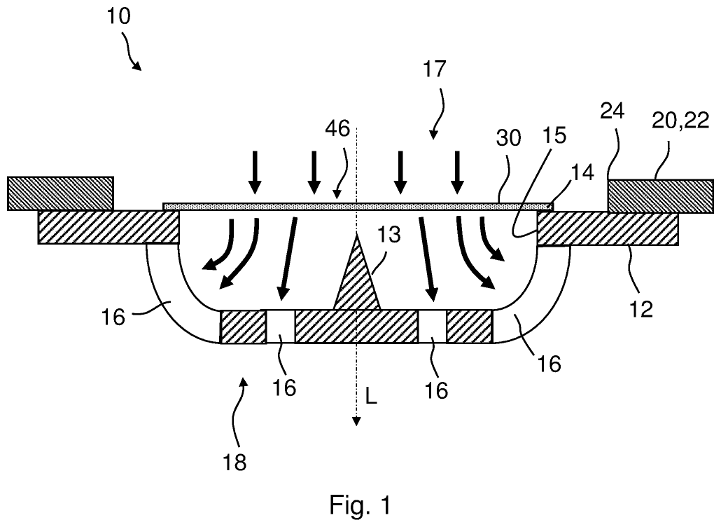

FIG. 1 shows a longitudinal section through a degassing unit 10 according to an embodiment example of the invention.

The degassing unit 10 for a housing 20, in particular of a battery, in particular of a traction battery of a motor vehicle, features a base body 12 which can be connected in a fluid-tight manner to an edge of a housing opening 24 of the housing 20 and an exterior side 18 with an interior side 17, wherein the interior side 17 is directed towards the housing opening 24.

Only a portion of the housing wall 22 with a housing opening 24 is visible of the housing 20. The housing opening 24 is closed by the degassing unit 10.

The base body features at least one gas passage opening 15, which is closed by a flat stretched membrane 30. The membrane 30 is fluid-tightly connected to the base body 12 at an edge 14 surrounding the gas passage opening 15.

The membrane 30 is present on the interior side 17 of the base body 12 and firmly connected to the base body 12. In particular, the membrane 30 may be welded to the base body 12.

The membrane 30 features at least one weakened area 46 in which mechanical properties of the membrane 30 are weakened by a local treatment, in particular a local melting of the material using a laser, and/or a mechanical treatment, in particular by means of scribing and/or embossing. As a result, a burst pressure at which the membrane 30 releases the gas passage opening 15 is reduced at least in the weakened area 46 compared to the untreated membrane 30.

In the at least one weakened area 46, a thickness of the membrane 30 is locally reduced. In particular, the weakened area 46 may feature, for example, a residual wall thickness of at least 5 μm, preferably of at least 8 μm.

The shape and/or size of the weakened area 46 of the membrane 30 may be formed as a function of a desired value of the burst pressure.

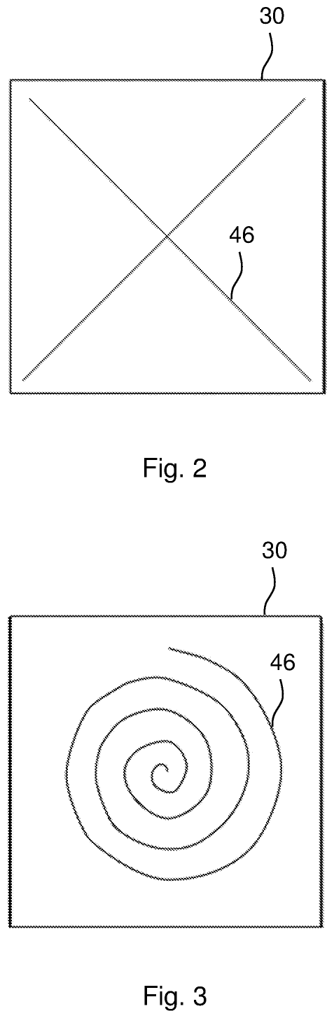

Various shapes of the weakened area 46 are shown in FIGS. 2 to 6, where in each case a top view of the membrane 30 with the weakened area 46 can be seen. The weakened area 46 may, for example, be linear or cross-shaped or rectangular or circular or spiral-shaped or grid-shaped at least in some areas. The weakened area 46 may be disposed on both sides of the membrane 30.

For example, the membrane 30 may be formed from a thermoplastic, in particular as a multilayer film, in particular from polypropylene or polyethylene terephthalate or polybutylene terephthalate.

In an alternative embodiment, it is possible that the membrane 30 is designed as a multilayer film and at least one film of the multilayer film, which is connected, in particular welded, to the base body 12, is formed from a material of the base body 12, in particular from polypropylene. A further film of the multilayer film may thereby be formed, for example, as a polymer film, in particular as an elastomer film.

In another example of an embodiment, the membrane 30 may also be designed as a composite film and/or hybrid film. In particular, the membrane 30 may be formed from a thermoplastic which is laminated and/or vapor-deposited with a metallic layer.

Advantageously, the membrane 30 may have a wall thickness of at least 30 μm and at most 200 μm. A film with such a wall thickness can be processed favorably during production.

The membrane 30 may be gas-tight or semi-permeable. As a semi-permeable membrane, the passage of gaseous media from an environment into the housing 20 and vice versa may thus be made possible and the passage of liquid media and/or solids may be prevented.

The base body 12 of the degassing unit 10 shown in FIG. 1 features an emergency degassing mandrel 13 disposed on the exterior side 18 and with a tip directed towards the interior side 17, by means of which the membrane 30, which is distended towards the exterior side 18 due to an overpressure in the housing 20, can be pierced.

FIG. 2 shows a top view of a membrane 30 of the degassing unit 10 according to an embodiment example of the invention.

The membrane 30 features a weakened area 46 which, in this example, is linear, with two lines lying crosswise on top of each other and arranged diagonally on the rectangular membrane 30. The lines may be applied by a local treatment of the membrane 30, in particular a local melting of the material using a laser, and/or a mechanical treatment, in particular by means of scribing and/or embossing. In the weakened area 46 of the lines, the mechanical properties of the membrane 30 have been weakened so that a burst pressure, at which the membrane 30 releases the gas passage opening 15 of the degassing unit 10, is reduced, at least in the weakened area 46, compared to the untreated membrane 30.

The at least one weakened area 46 is, for example, linear or cross-shaped or rectangular or circular or spiral-shaped or grid-shaped at least in some areas.

As an alternative, a top view of a membrane 30 with a spiral-shaped line pattern of the weakened area 46 can be seen in FIG. 3.

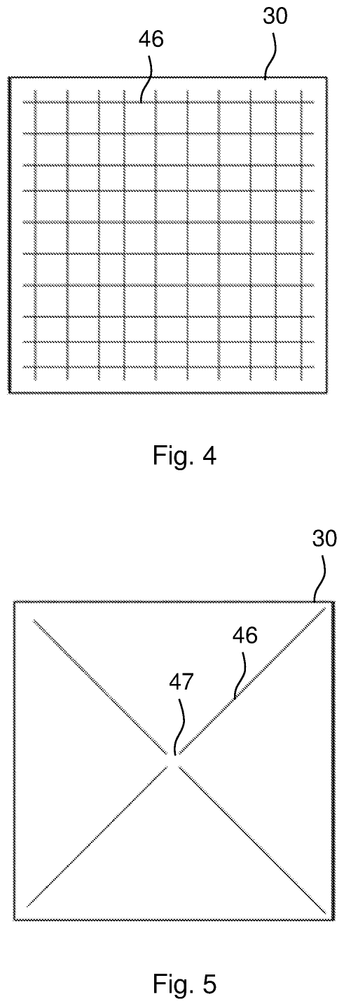

FIG. 4 shows a top view of a membrane 30 with a grid-shaped line pattern of the weakened area 46.

FIG. 5 shows a top view of a membrane 30 with a linear line pattern of the weakened area 46. In this case, four lines each are extending diagonally into the membrane 30, while a central area 47 of the membrane 30 remains unweakened. Advantageously, by keeping the central area 47 of the membrane 30 unweakened, the membrane 30 may not break or burst while forming the weakened area 46 of the membrane 30 during manufacturing of the membrane 30.

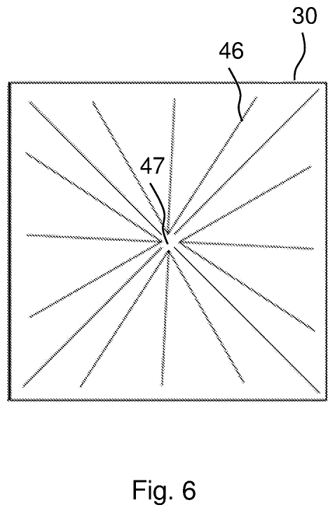

FIG. 6 shows a top view of a membrane 30 with a further linear line pattern of the weakened area 46. In this case, numerous lines extend in a star-shaped manner from a central area 47 to the edge of the membrane 30. The central area 47 remains unweakened.

1. A degassing unit for a housing, the degassing unit comprising:
a membrane; and
a base body connectable in a fluid-tight manner to an edge of a housing opening of the housing and comprising an exterior side, an interior side, and a gas passage opening that is closed by the membrane,
wherein the membrane is fluid-tightly connected to the base body at an edge surrounding the gas passage opening,
wherein the membrane comprises weakened areas in which mechanical properties of the membrane are weakened by any one or any combination of a local melting of a material using a laser, scribing and embossing,
wherein the membrane further comprises a central area interposed between the weakened areas, the central area remaining unweakened, and
wherein a burst pressure at which the membrane releases the gas passage opening is reduced at least in the weakened areas compared to the central area.

2. The degassing unit according to claim 1, wherein the weakened areas of the membrane comprise four lines extending diagonally from the central area to an edge of the membrane.

3. The degassing unit according to claim 1, wherein the weakened areas of the membrane comprise multiple lines extending in a star-shaped manner from the central area to an edge of the membrane.

4. The degassing unit according to claim 1, wherein, in the weakened areas, a thickness of the membrane is reduced to at least 5 μm.

5. The degassing unit according to claim 1, wherein the membrane is formed from one among polypropylene, polyethylene terephthalate and polybutylene terephthalate.

6. The degassing unit according to claim 1, wherein the membrane is a multilayer film,
wherein at least one film of the multilayer film is welded or bonded to the base body and is formed from a material of the base body, and
wherein a further film of the multilayer film is an elastomer film.

7. The degassing unit according to claim 1, wherein the membrane is formed from a thermoplastic that is laminated and/or vapor-deposited with a metallic layer.

8. The degassing unit according to claim 1, wherein the membrane has a wall thickness of at least 30 μm and at most 200 μm.

9. The degassing unit according to claim 1, wherein at least one of the weakened areas is disposed on both sides of the membrane.

10. The degassing unit according to claim 1, wherein the membrane is gas-tight or semi-permeable, so that a passage of gaseous media from an environment into the housing and vice versa is made possible and a passage of liquid media and/or solids is prevented.

11. The degassing unit according to claim 1, wherein the base body comprises an emergency degassing mandrel disposed on the exterior side and with a tip directed towards the interior side, the tip being configured to pierce the membrane that is distended towards the exterior side due to an overpressure in the housing.

12. The degassing unit according to claim 1, wherein the membrane is welded or bonded to the base body.

13. The degassing unit according to claim 1, wherein the membrane is disposed on the interior side of the base body.

14. A membrane for a degassing unit, the membrane comprising:
weakened areas in which mechanical properties of the membrane are weakened by any one or any combination of a local melting of a material using a laser, scribing and embossing; and
a central area interposed between the weakened areas, the central area remaining unweakened,
wherein a burst pressure at which the membrane releases a gas passage opening of the degassing unit is reduced at least in the weakened areas compared to the central area.

15. The membrane according to claim 14, wherein the weakened areas of the membrane comprise four lines extending diagonally from the central area to an edge of the membrane.

16. The membrane according to claim 14, wherein the weakened areas of the membrane comprise multiple lines extending in a star-shaped manner from the central area to an edge of the membrane.

17. A method of manufacturing a membrane for a degassing unit, the method comprising:
forming, in the membrane, weakened areas in which mechanical properties of the membrane are weakened by any one or any combination of a local melting of a material using a laser, scribing and embossing; and
forming, in the membrane, a central area interposed between the weakened areas, the central area remaining unweakened,
wherein a burst pressure at which the membrane releases a gas passage opening of the degassing unit is reduced at least in the weakened areas compared to the central area.

18. The method according to claim 17, wherein the weakened areas of the membrane comprise four lines extending diagonally from the central area to an edge of the membrane.

19. The method according to claim 17, wherein the weakened areas of the membrane comprise multiple lines extending in a star-shaped manner from the central area to an edge of the membrane.
